(19) United States
(12) Patent Application Publication
(10) Pub. No.: US 2003/0202737 A1
(43) Pub. Date: Oct. 30, 2003

(54) Optical switch

(76) Inventor: Mingbao Zhou, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/295,408

(22) Filed: Nov. 15, 2002

(30) Foreign Application Priority Data
Apr. 25, 2002 (TW) 91205684

(51) Int. Cl. G02B 6/35

(52) U.S. Cl. 385/16

(57) ABSTRACT

An optical switch includes an input port (200) having an input fiber (201), an output port (300) having a plurality of output fibers (301), a switching element (400), a driving device (500) and a base (600). The input port, the output port and the driving device are mounted on the base. The driving device can drive the switching element to rotate between a plurality of positions. As the switching element is rotated to a position, input light beams coming from the input fiber can be switched by the switching element to a corresponding output fiber.

### BACKGROUND OF THE INVENTION

1. Field of the Invention

The present invention relates to an optical switch for use in fiber communication and optical network technology, and particularly to a mechanically operated optical switch with a rotatable prism as a switching element. A copending application having the same applicant, the same assignee and the same title with the invention is referenced hereto.

2. Description of Related Art

Optical signals are commonly transmitted in optical fibers, which provide efficient light channels through which the optical signals can pass. Recently, optical fibers have been used in various fields, including telecommunications, where light passing through an optic fiber is used to convey either digital or analog information. Efficient switching of optical signals between individual fibers is necessary in most optical processing systems or networks to achieve the desired routing of the signals.

Various fiber optic systems, employing different methods have been previously developed for switching optical signals between fiber cables. In these previously developed systems, one important category is mechanical optical switch.

Mechanical optical switches come in two different designs: in one design, the optical components move, and in the other design, the fibers move. Factors for assessing the capability of an optical switch include low insertion loss (<1 dB), good isolation performance (>50 dB) and bandwidth capacity compatible with the optical network.

Moving fiber switches involve the actual physical movement of one or more of the fibers to specific positions to accomplish the transmission of a beam of light from one fiber end to another under selected switching conditions. Moving optical component switches, on the other hand, include optical collimating lenses, which expand the beam of light from the fibers, and moving prisms or mirrors, which reswitch the expanded beam as required by the switching process.

The moving fiber switches have a stringent tolerance requirement for the amount and direction of fiber movement. The tolerance is typically a small fraction of the fiber core diameter for two fibers to precisely align to reduce losses. The fibers themselves are quite thin and may be subject to breakage if not properly protected. On the other hand, reinforcing the fibers with stiff, protective sheaths makes the fibers less flexible, increasing the force required to manipulate each fiber into alignment. Thus, these moving fiber optical switches share a common problem of requiring high precision parts to obtain precise positioning control and low insertion loss. This results in high costs and complicated manufacture of the switches. Moreover, frequently moving fibers to and fro is apt to damage or even break the fibers.

The moving optical component switches have less stringent movement control tolerance requirements because of the collimating lenses.

As illustrated in FIG. 10, CN Patent Application Number 00240684 discloses an optical switch which comprises a port 10, a prism assembly 12 having two prisms 121, 122, and a reflector assembly 13 having two reflectors 131, 132. The port 10 has an input fiber 101, two output fibers 102, 103 and a collimating lens 104. When the first reflector 131 is positioned in the light path, the light from the input fiber 101 is reflected (at point A) to the output fiber 102. When the first reflector 131 is out of the light path (at an upper position 131′), the light from the input fiber 101 is reflected by the second reflector 132 (at point B) to the output fiber 103. However, the structure of the switch is complex, the size is relatively large, and the aligning process is more involved, because of the presence of the prism assembly and the reflector assembly.

As illustrated in FIG. 11, U.S. Pat. No. 5,420,946 describes an optical coupling switch for coupling light beams from an input port 14 into a selected output port 16. The input fiber 141 is optically aligned with one of a plurality of output fibers 161 via a switching element 15. By rotating the reflector 152 attached to a block 151 of the switching element 15 about an axis 153, the input light beam can be reflected to a selected output fiber 161. The input fiber 141 and all the output fibers 161 are in fixed positions relative to each other.

In this mechanical switch, the plurality of output fibers 161 are separately mounted on a platform, which makes the structure of the switch more complex, the size large, and the aligning process between the input fiber 141 and the plurality of output fibers 161 are complicated. In addition, the mechanical switch uses a plurality of GRIN lenses 162, 142 on front ends of the output fibers 161 and the input fiber 141 to collimate the light beams, which adds greatly to the cost of the mechanical switch.

For the above reasons, an improved optical switch is desired. In particular, an optical switch is desired which has high optical efficiency, is easy to align, and does not require movement of the optical fibers themselves.

### SUMMARY OF THE INVENTION

An object of the present invention is to provide an optical switch which allows easy alignment of associated components and fibers.

Another object of the present invention is to provide an optical switch which is low in cost.

An optical switch in accordance with one embodiment of the present invention, comprises an input port, an output port, a switching element, a driving device and a base.

The input port comprises an input fiber and a first collimating lens. The output port comprises a plurality of output fibers and a second collimating lens. The switching element is assembled between the input port and the output port.

Input light beams from the input fiber are transmitted through the first collimating lens, which collimates the dispersed input light beams to parallel light beams. These parallel light beams pass through the switching element, which refracts and redirects the parallel light beams in a predetermined direction. The redirected parallel light beams then pass through the second collimating lens of the output port, which converges the light beams into one predetermined output optical fiber. The switching element is driven to rotate between a plurality of positions, and when the switching element is placed in one position, the input light beams are deflected by the switching element to one corresponding output fiber.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an optical switch according to the present invention;

FIG. 2 is a schematic, cross-sectional view taken along the line 2-2 in FIG. 1;

FIG. 3 is a schematic, cross-sectional view taken along the line 3-3 in FIG. 1;

FIG. 4 is a schematic, cross-sectional view taken along the line 4-4 in FIG. 2;

FIG. 5 is a schematic, cross-sectional view taken along the line 5-5 in FIG. 4, without a quartz sleeve and a metal tube;

FIG. 6 is a schematic, cross-sectional view taken along the line 6-6 in FIG. 2;

FIG. 7 is a schematic, cross-sectional view of an inner core of a multi-fiber ferrule;

FIG. 8 is a right side elevational view of the inner core of the multi-fiber ferrule;

FIG. 9 is an essential optical paths diagram of the optical switch in FIG. 1;

FIG. 10 a schematic diagram of a prior art optical switch; and

FIG. 11 a perspective view of another prior art optical switch.

### DETAILED DESCRIPTION OF THE INVENTION

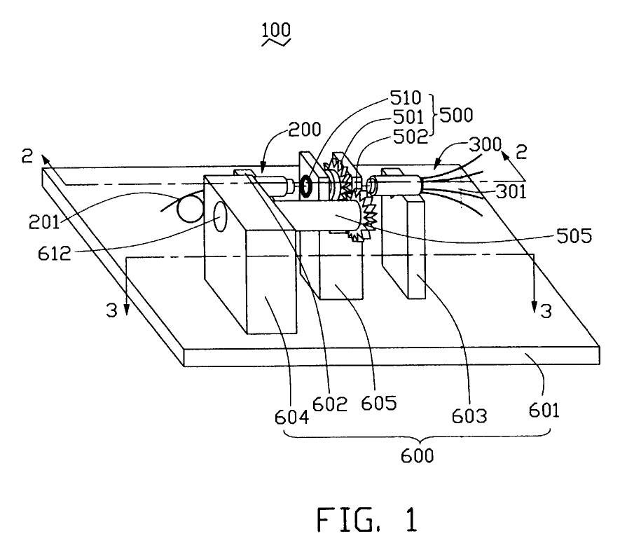

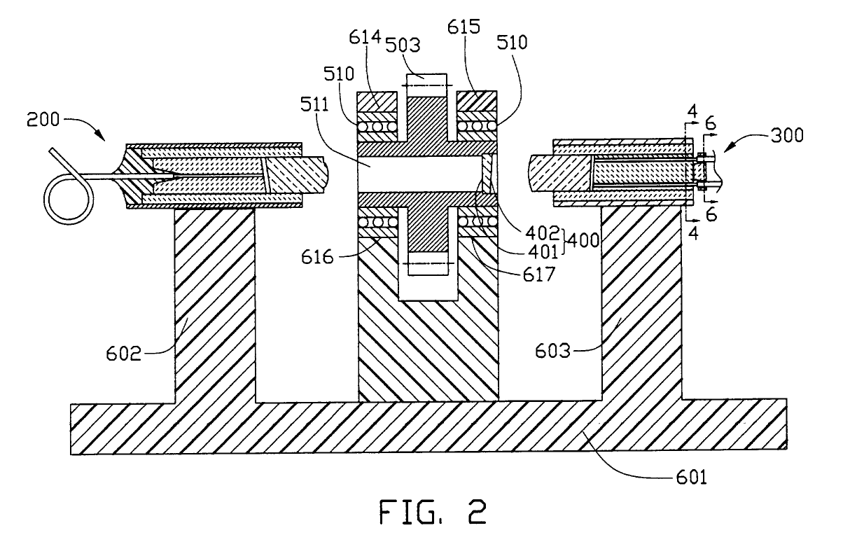

Referring to FIGS. 1 and 2, an optical switch 100 of a preferred embodiment of the present invention comprises an input port 200, an output port 300, a switching element 400, a driving device 500 and a base 600 for mounting the input port 200, the output port 300 and the driving device 500 thereon.

As shown in FIGS. 1, 2 and 3, the base 600 has a substrate 601 and four upright beams 602, 603, 604, 605 extending upwardly from the substrate 601. The upright beams 602, 603, 605 are arranged in a line for coaxial alignment of the input port 200, the output port 300. The upright beam 604 defines a through hole 612. The upright beam 605 has two arms 614, 615 defining two mounting holes 616, 617 therein, respectively. A recess (not labeled) is defined in upright beam 605 between the two arms 614, 615.

The input port 200 comprises an input fiber 201, a ferrule 210, a first collimating lens 220 aligning with the ferrule 210, and a quartz sleeve 230 receiving the first collimating lens 220 and the ferrule 210 therein. The ferrule 210 defines a through hole 211, which accommodates an exposed portion of the input fiber 201. The input fiber 201 is fixed in the through hole 211 with epoxy resin. The first collimating lens 220, which can be a molded lens having a single index, partially extends out of the quartz sleeve 230. The input port 200 further has a metal tube 240 surrounding the quartz sleeve 230 for protecting the input port 200.

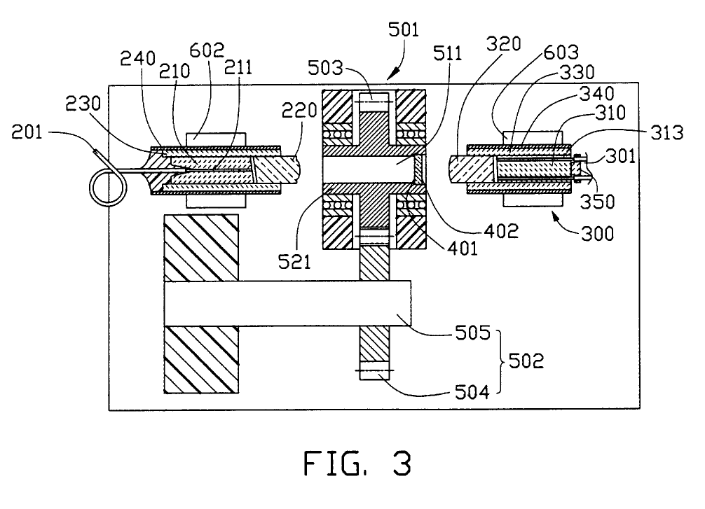

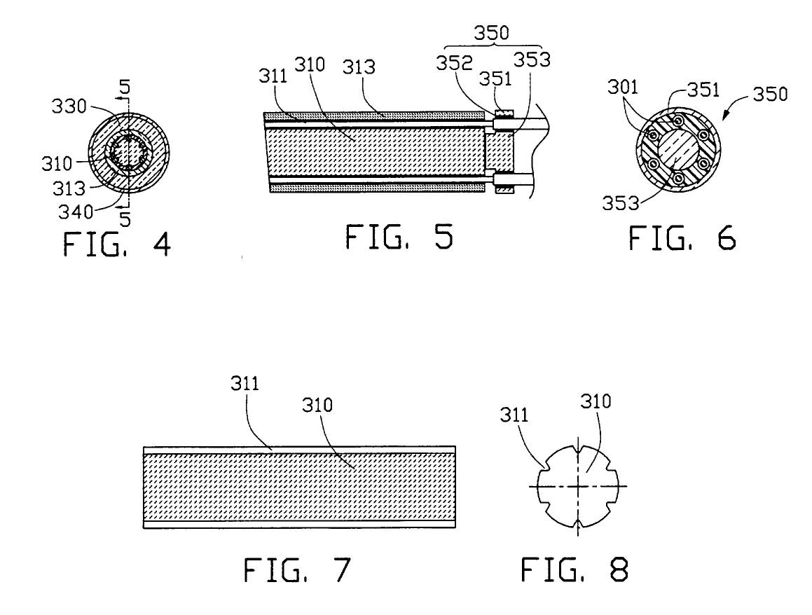

Referring to FIGS. 3˜8, the output port 300 has a multi-fiber ferrule (not labeled), a plurality of output fibers 301, a second collimating lens 320, a fiber holder 350 and a quartz sleeve 330. The multi-fiber ferrule comprises a core 310 and a sleeve 313 surrounding the core 310. A plurality of grooves 311, apart, are defined in an exterior surface (not labeled) of the core 310. Each output fiber 301 has an exposed end portion is mounted in a corresponding groove 311 of the multi-fiber ferrule. The second collimating lens 320 has a single index and aligns with the output fibers 301. The fiber holder 350 comprises a ring 351 and a support portion 353. A space 352 is formed between the ring 351 and support portion 353 to receive and fix the fibers 301. The fiber holder 350 is attached to the multi-fiber ferrule using epoxy resin. The quartz sleeve 330 receives and fixes multi-fiber ferrule and the second collimating lens 320 therein. The second collimating lens 320 is a molded lens and partially extends out of the quartz sleeve 330. The output port 300 further has a metal tube 340 surrounding the quartz sleeve 330 for protecting the output port 300.

Referring to FIGS. 1-3, the driving device 500 comprises a cogwheel 501, two roller bearings 510, a driving gear 502 and an actuator (not shown). The cogwheel 501 has a gear wheel 503 mounted on a tubular axle 521. The tubular axle 521 has a through hole 511 extending longitudinally therethrough. The driving gear 502 has a shaft 505 and a driving gear wheel 504. The two roller bearings 510 are arranged in the two mounting holes 616, 617, respectively, wherein an outside diameter of each roller bearing 510 is slightly less than an inside diameter of the mounting holes 616, 617.

The switching element 400 is a prism having a first and a second antiparallel planar end surfaces 401, 402. The first planar end faces 401 is perpendicular to an optical axis between the input and output ports 200, 300, said optical axis substantially coinciding with a longitudinal axis of the tubular axle 521. The second planar end face 402 makes an angle with the first planar end face 401.

In assembly, the input port 200 and the output port 300 and the are fixed in the upright beams 602, 603. The switching element 400 is accommodated and fixed in the through hole 511 of the cogwheel 501. The two roller bearings 510 are received in the mounting holes 616, 617 of the upright beam 605. The cogwheel 501 is rotatably mounted to the upright beam 605 with the gear wheel 503 being received in the recess (not labeled) between the two arms 614, 615 of the upright beam 605, and each of two opposite ends of the tubular axle 521 being supported in a corresponding roller bearing 510. The first planar end face 401 and the second planar end face 402 of the switching element 400 face the input port 200 and the output port 300, respectively. The shaft 505 of the driving gear 502 is fixed in the through hole 612 of the upright beam 604. The actuator (not shown) drives the shaft 505 to rotate, which rotates the driving gear wheel 504 and the cogwheel 501. The switching element 400 rotates with the cogwheel 501.

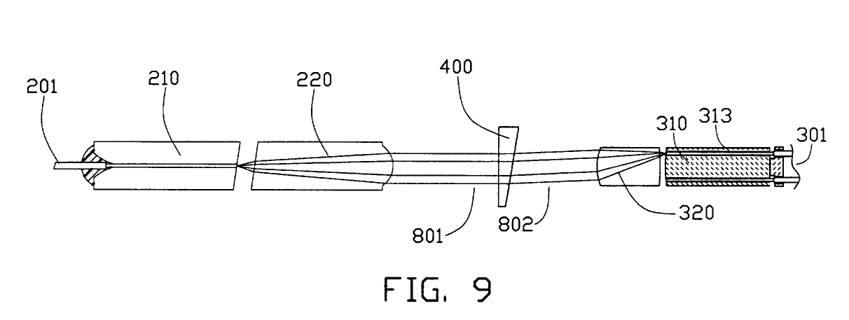

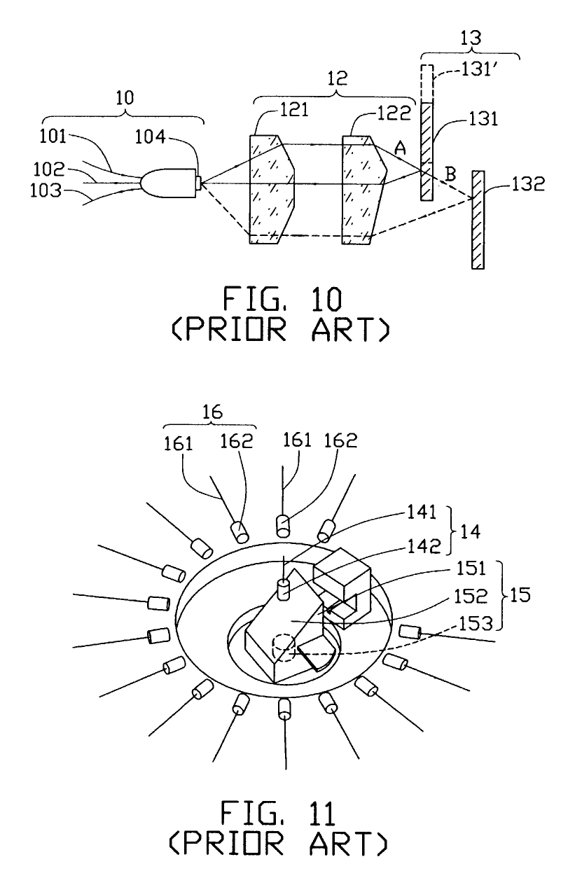

FIG. 9 shows an essential optical paths diagram of the optical switch 100. Input light beams from the input fiber 201 are transmitted through the first collimating lens 220, which collimates the dispersed input light beams to parallel light beams 801, The parallel light beams 801 pass through the switching element 400, which refracts and redirects the parallel light beams in a predetermined direction. The refracted and redirected parallel light beams 802 pass through the second collimating lens 320, which focuses the light beams into one predetermined output optical fiber 301.

In operation, the switching element 400 is driven to rotate between a plurality of positions by means of the actuator (not shown) driving the shaft 505 and the driving gear wheel 504, which drives the cogwheel 501 in which the switching element 400 is mounted. As the switching element 400 is rotated to each successive position, the parallel light beams 801 (see FIG. 9) are deflected in a different, predetermined direction, and the light beams are switched a different corresponding output fiber 301.

Advantages of the optical switch 100 of the present invention over the prior art include the following. First, only optical components of the switch move; no fibers move. Second, the input and output ports are easily aligned with one another. Third, using a multi-fiber ferrule to accommodate a plurality of optical fibers decreases the size and costs of the switch, compared with the large size, high cost prior art design, which has separately mounted output optical fibers and a plurality of GRIN lenses.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An optical switch comprising:
a first collimating lens aligning with an input fiber;
a second collimating lens aligning with a plurality of output fibers mounted in a multi-fiber ferrule;
a switching element being arranged between the first and second collimating lenses; and
a driving device driving the switching element to rotate to switch input light beams from the input fiber between different output fibers, the driving device comprising a cogwheel defining a through hole;
wherein the switching element is received and fixed in the through hole of the cogwheel and rotates together with the cogwheel.

2. The optical switch as claimed in claim 1, wherein the switching element can be a prism with two antiparallel surfaces.

3. The optical switch as claimed in claim 1, wherein the driving device further comprises a driving gear having a shaft and a driving gear wheel, the driving gear couples with the cogwheel.

4. The optical switch as claimed in claim 3, further comprising an actuator driving the shaft, which drives the driving gear wheel, which driving the cogwheel to rotate.

5. The optical switch as claimed in claim 4, wherein the cogwheel comprises a tubular axle and a gear wheel mounted on the tubular axle, the through hole is defined in the tubular axle.

6. The optical switch as claimed in claim 1, wherein the multi-fiber ferrule comprises a core, the multi-fiber ferrule defines a plurality of evenly-spaced grooves in an exterior surface of the core, and the plurality of output fibers are mounted in corresponding grooves.

7. The optical switch as claimed in claim 6, wherein the multi-fiber ferrule further comprises a sleeve surrounding the core to stably mount the output fibers in the grooves of the multi-fiber ferrule.

8. The optical switch as claimed in claim 7, further comprising a metal tube and a quartz sleeve, the quartz sleeve surrounding and fixing the multi-fiber ferrule and the second collimating lens therein, and metal tube surrounding and fixing the quartz sleeve therein.

9. The optical switch as claimed in claim 1, further comprising a ferrule holding the input fiber therein.

10. The optical switch as claimed in claim 8, further comprising a metal tube and a quartz sleeve, the quartz sleeve surrounding and fixing the ferrule and the first collimating lens therein, and metal tube surrounding and fixing the quartz sleeve therein.

11. 10. An optical switch for switching light beams between one input optical fiber and a plurality of output optical fibers, comprising:
a first collimator for aligning with the input optical fiber and collimating input light beams;
a second collimator for aligning with the output optical fibers and decollimating output light beams; and
a rotatable optical element arranged between the first and second collimators;
the rotatable optical element having a different refractive index from circumambient media and two antiparallel surfaces, which is rotatable among a plurality of positions; whereby, when the optical element is in different positions, the light beams from the input optical fiber are switched to reoperative different output optical fibers; wherein
the second collimator including a core supporting bared fibers and a coaxial support portion supporting jacketed fibers.
